(19) United States
(12) Patent Application Publication
(10) Pub. No.: US 2016/0286032 A1
(43) Pub. Date: Sep. 29, 2016

(54) MODIFYING OPERATION OF A MOBILE COMMUNICATION DEVICE BASED ON INTEREST LEVEL IN A GEOGRAPHIC LOCATION

(71) Applicant: Lenovo Enterprise Solutions (Singapore) Pte. Ltd., Singapore (SG)

(72) Inventors: Gary D. Cudak, Wake Forest, NC (US); Christopher J. Hardee, Raleigh, NC (US); Adam Roberts, Moncure, NC (US); Adrian X. Rodriguez, Durham, NC (US)

(21) Appl. No.: 14/666,515

(22) Filed: Mar. 24, 2015

(51) Int. Cl. H04M 1/725; H04W 76/04; H04W 4/02

(52) U.S. Cl. CPC H04M 1/72572; H04W 4/021; H04W 76/046

(57) ABSTRACT

A method and a computer program product are provided, where the computer program product includes program instructions that are executable by a processor to cause the processor to perform the method. The method includes determining an interest level in a geographic location, and, in response to a mobile communication device being present in the geographic location, automatically altering operation of the mobile communication device based on the interest level. For example, the operation of the mobile communication device may be automatically altered by loading an application that may be desired in a geographic location having the determined interest level.

### BACKGROUND

1. Field of the Invention

The present invention relates to the operation of a mobile communication device, and more specifically relates to the use of applications on a mobile communication device.

2. Background of the Related Art

Mobile communication devices, such as telephones, are an integral part of everyday life in a modern society. Telephones that are connected to a land line are even on the decline, as people become accustomed to having a mobile phone with them at all times. The functions and features available on a mobile phone continue to expand, including applications or “apps”, a web browser, a camera, full physical or virtual keypads, touchscreens, wifi and Bluetooth connectivity, texting and email, and more.

However, along with the growing number and types of apps that may be available on a mobile communication device, it has become more cumbersome to locate and access the icon associated with a desired app. Furthermore, a user may not have advance knowledge of which app they will want to use in various circumstances or locations.

### BRIEF SUMMARY

One embodiment of the present invention provides a computer program product comprising a computer readable storage medium having program instructions embodied therewith, where the program instructions are executable by a processor to cause the processor to perform a method. The method comprises determining an interest level in a geographic location, and, in response to a mobile communication device being present in the geographic location, automatically altering operation of the mobile communication device based on the interest level.

Another embodiment of the present invention provides a method comprising determining an interest level in a geographic location, and, in response to a mobile communication device being present in the geographic location, automatically altering operation of the mobile communication device based on the interest level.

### BRIEF DESCRIPTION OF THE SEVERAL VIEWS OF THE DRAWINGS

FIG. 1 is a block diagram of the components of a mobile communication device in accordance with one embodiment of the invention.

FIG. 2 is a diagram of a system including a communication network enabling communication with and between a plurality of mobile communication devices.

FIG. 3 is a diagram of an exemplary server that may be utilized as the network management server or remote server consistent with various embodiments of the present invention.

FIG. 4 is a diagram of a mobile communication device having a display screen displaying a user interface with various icons each representing an application.

FIG. 5 is a diagram of the mobile communication device after having modified the user interface to facilitate access to a particular application icon.

FIG. 6 is a flowchart of a method in accordance with one embodiment of the present invention.

### DETAILED DESCRIPTION

One embodiment of the present invention provides a computer program product comprising a computer readable storage medium having program instructions embodied therewith, where the program instructions are executable by a processor to cause the processor to perform a method. The method comprises determining an interest level in a geographic location, and, in response to a mobile communication device being present in the geographic location, automatically altering operation of the mobile communication device based on the interest level.

The presence of a mobile communication device in a particular geographic location may be determined in various manners. For example, a modern mobile communication device typically includes a global positioning system transceiver that receives signals from a global positioning system that allow the mobile communication device to determine its location with accuracy to within a few feet. Alternatively, a rough measure of the location of a mobile communication device may be determined by the cellular communication tower that is presently managing communications with the mobile communication device. Still further, location or environmental cues may be obtained by sounds, images or vibrations detected by the mobile communication device.

A geographic location may be any area with a distinguishing characteristic and geographic location may overlap. Non-limiting examples of geographic locations include: governmental entities such as countries, states and municipalities; business and commercial properties such as malls, theaters and restaurants; recreational areas such as parks, zoos, and stadiums; historic and tourism sites; and event destinations such as convention centers, concert halls and auditoriums. These and other geographic locations may be delineated in various measure, such as global positioning system coordinates, proximity to a cellular communication tower, blue-tooth or WiFi detection, and the like. Non-limiting examples of overlapping geographic locations may include a public park that features a zoo, or a historic district that includes an outdoor amphitheater.

Modern mobile communication devices include many capabilities that may be controlled by an operating system and application software. The application software is often written by third party software developers and organized into separate modules commonly referred to as applications or “apps”. A mobile communication device may store many different apps that the user selects for loading as desired. Such apps may be downloaded from app stores or other websites and vary in function, for example including games, music players, camera features, weather reports, traffic reports, news channels, web browsers, restaurant reservations systems, electronic book readers, electronic payment systems, and the like.

Embodiments of the present invention may take any of variety of actions to automatically alter operation of the mobile communication device based on the interest level in a geographic location of the mobile communication device. For example, program instructions may automatically place the mobile communication device in a sleep mode in response to determining that the interest level in the geographic location is less than a first predetermined interest threshold. In a similar example, program instructions may automatically waking the mobile communication device out of a sleep mode in response to determining that the interest level in the geographic location is greater than a second predetermined interest threshold.

Other embodiments of the present invention may take various other actions to automatically alter operation of the mobile communication device based on the interest level in a geographic location of the mobile communication device. For example, program instructions may cause the mobile communication device to automatically load a first application, such as a camera application or social media application, in response to determining that the interest level in the geographic location is greater than a first predetermined interest threshold. In a similar example, program instructions may cause the mobile communication device to automatically load a second application, such as a gaming application or social media application, in response to determining that the interest level in the geographic location is less than a second predetermined interest threshold.

In a further embodiment, the method may identify content that is accessed the most by mobile communication devices in the geographic location. Accordingly, the method may further include the mobile communication device automatically loading an application that will access that content. Still further, the mobile communication device may automatically downloading the content using the application.

It should be recognized that embodiments of the present invention may be implemented entirely by the mobile communication device or with varying degrees of participation by a remote server. A method may be implemented entirely by a mobile communication device where the interest level is determined by an individual device usage history, perhaps including a specific identification of applications that were used in particular geographic locations in the past. However, when the mobile communication device is in a new geographic location or new type of geographic location then the individual device usage history may not provide an adequate indication of an interest level or applications that should be loaded for use. Accordingly, a server may communicate with any number of mobile communication devices over a communications network to collect usage data over any relevant time period. This collection of usage data enables an overall interest level to be determined and relevant apps to be selected even for a mobile communication device that has never before been to the geographic location or a similar type of geographic location. For example, an interest level in the geographic location may be determined by whether or not a majority of mobile activity in the geographic location is related to the geographic location.

In one implementation, the method may identify content that is accessed the most by mobile communication devices in the geographic location, and then storing the identified content at an access point of a mobile communication network that is nearest to the geographic region. For example, the content may be accessed using a web browser app. Since the identified content is frequently accessed by mobile communication devices in the geographic region, storing that content at a proximate access point will reducing congestion in the mobile communication network.

In another implementation, the method may identify a type of application that is used the most by mobile communication devices in the geographic location, identify an application on the mobile communication device that is the identified type of application, and the mobile communication device automatically loading the identified application. For example, if the type of application that is most-used by mobile communication devices in a geographic location is a social media app, then an individual mobile communication device would identify and load the user's favorite or only social media app. Since individual users may use different social media apps, different apps are loaded on different mobile communication devices. In a similar implementation, the method may identify a type of application that is used the most by mobile communication devices in the geographic location, identify an application on the mobile communication device that is the identified type of application, and automatically direct the user interface of the mobile communication device to display an icon for the identified application. Accordingly, this latter implementation facilitates or suggests use of the app without actually automatically loading the suggested app.

In yet another implementation, the method may identify a location type for the geographic location, maintain a list of location types and an application associated with each location type, and the mobile communication device automatically loading the application that is associated with the identified location type. For example, a geographic location may be identified by the location type “arboretum” and a list may associate a camera app with arboretums. Accordingly, the mobile communication device arriving at the arboretum would automatically load its camera application. As another example, a geographic location may be identified by the location type “highway” and the list may associate a traffic or weather app with highways.

An interest level may be determined by tracking application usage or activity by application type and frequency on a user's mobile communication device. This data can then be used to determine how interesting an area or event is by the type and frequency of application usage. More specifically, useful data collection may include, without limitation, categorizing applications by type, storing application use frequency and duration, storing geographic location of the application use, demographic data representing the user, typical average application usage, and knowledge of attendance at an event. For example, application types may include camera applications (e.g., taking pictures of the area is a positive indication of interest), games or other time sinks (e.g., playing games is a negative indication of interest), web browser applications (where a determination of content matching the geographic location indicates positive interest and content mismatching indicates negative interest), and social media applications (where a determination of content matching the geographic location indicates positive interest and content mismatching indicates negative interest). The frequency or duration of application use may be a particular indication of interest or disinterest in a geographic location when the application is currently being used more than normal.

Furthermore, an interest level may be a Boolean value, such as either interesting (“+” or “1”) or not interesting (“−” or “0”). Alternatively, an interest level may be a calculated score based on various scoring criterion. For example, a “level of interest” score may be determined in consideration of the level of application usage or activity in a given geographic location compared to the average application usage or activity in other geographic locations. For example, each picture taken with a camera application beyond an average picture taking frequency may score a point, each post to social media or each internet query with context matching the geographic location may score half a point, and the use of gaming or other distractive applications (web browsers or social media with no context match to applications) beyond an average game or distractive application use rate may cause a point to be subtracted.

A server may collect usage data from numerous mobile communication device in various geographic locations over periods of time, determine interest levels for the various geographic location, and provide interest levels to other mobile communication devices as they are found to be present in the geographic location. Where the server has knowledge of a specific event, such as a concert, movie, or show, occurring in the geographic location, a new data set may be collected and used to determine an interest level that is specific to the event.

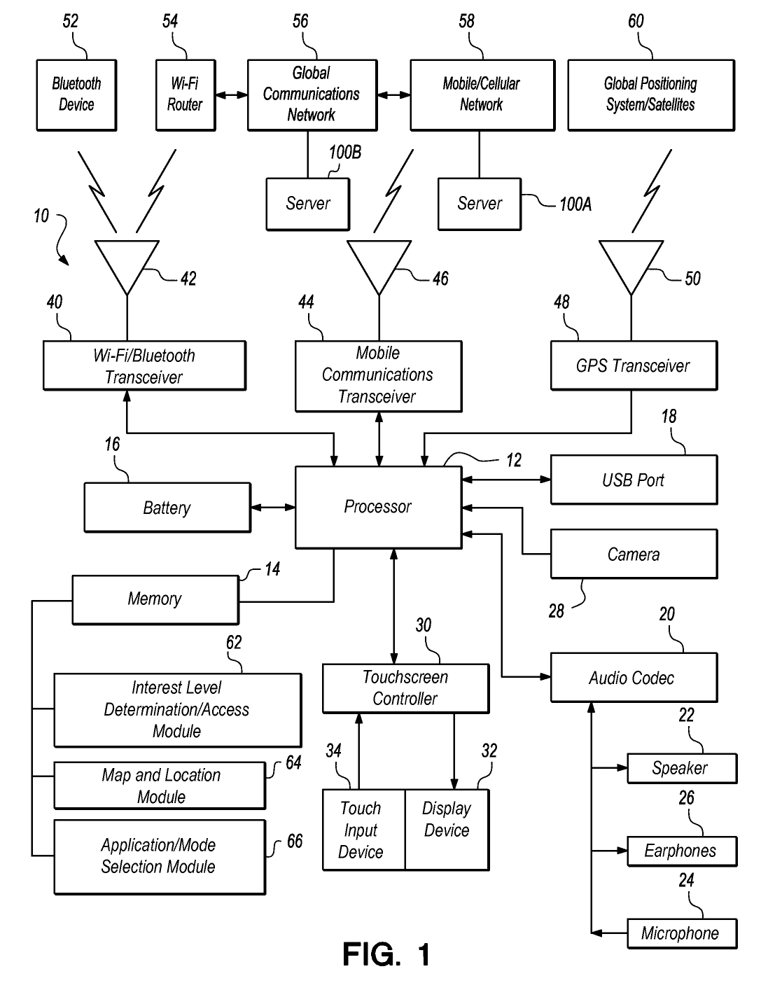

FIG. 1 is a block diagram of the components in one example of a mobile communication device 10, such as a smart phone, capable of implementing embodiments of the present invention. The mobile communication device 10 may include a processor 12, memory 14, a battery 16, a universal serial bus (USB) port 18, a camera 28, and an audio codec 20 coupled to a speaker 22, a microphone 24, and an earphone jack 26. The mobile communication device 10 may further include a touchscreen controller 30 which provides a graphical output to the display device 32 and an input from a touch input device 34. Collectively, the display device 32 and touch input device 34 may be referred to as a touchscreen.

The mobile communication device 10 may also include a Wi-Fi and/or Bluetooth transceiver 40 and corresponding antenna 42 allowing the device to communicate with a Bluetooth device 52 or a Wi-Fi router 54, a mobile communication transceiver 44 and corresponding antenna 46 allowing the device to communicate over a mobile/cellular network 58, and a global positioning system (GPS) transceiver 48 and corresponding antenna 50 allowing the device to obtain signals from a global positioning system or satellites 60. In a non-limiting example, the Wi-Fi router 54 and the mobile/cellular network 58 may be connected to a global communications network 56, such as the Internet. Furthermore, mobile/cellular network 58 or global communications network 56 may include or access a server 100A, 100B that may be used along with the mobile communication device 10 to implement various embodiments of the present invention. When the mobile communication device 10 has memory 14 with sufficient capacity, the data storage and logic functions of the present invention may be implemented entirely within the mobile communication device itself. As shown, the memory 14 stores an interest level determination/access module 62, a map and location module 64, and an application/mode selection module 66. Each module includes program instructions with logic to perform the functions of the present invention. Each module may include or access the data needed to support those functions, such as the application usage and activity data that forms the basis of the interest level determination, any list associating a geographic location type with an application, and other data disclosed herein.

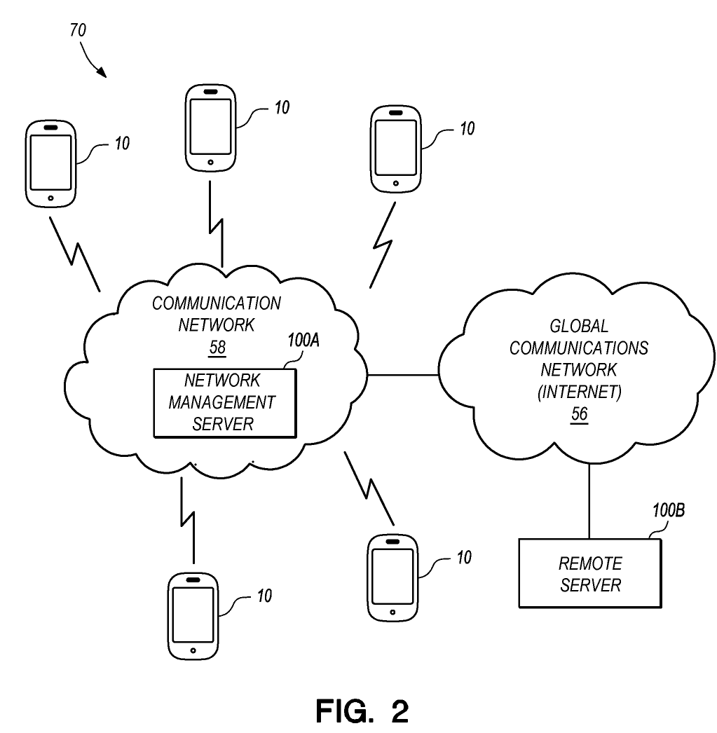

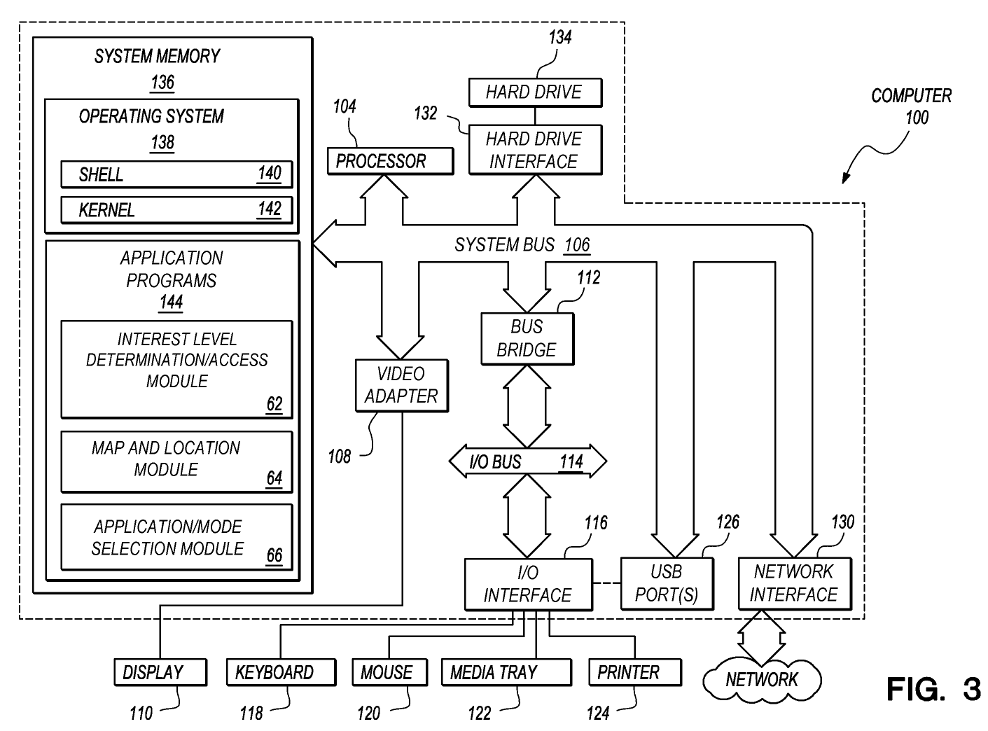

FIG. 2 is a diagram of a system 70 including a communication network 58 enabling communication with and between a plurality of mobile communication devices 10. The communication network 58 may be managed by a network management server 100A, which may implement features of the present invention. The network management device 100A may be responsible for establishing connections between communications devices, and may also provide one or more services to the communications devices. For example, although the methods of the invention may be implemented within the mobile communication devices 10 it is also possible to implement one or more steps of the methods or one or more functions of the present invention in the network management server 100A. In one non-limiting example, the network management server 100A may run an interest level determination/access module 62, a map and location module 64, and/or an application/mode selection module 66 (See FIG. 3).

The communication network 58 may also allow communication with a global communications network 56, such as the Internet. Accordingly, a remote server 100B may be in communication with the mobile communication devices 10. A history of application use and activity may be maintained on the individual mobile communication devices 10, the network management server 100A, the remote server 100B or one or more similar servers.

FIG. 3 is a diagram of an exemplary compute node or server (or simply “computer”) 100 that may be utilized as the network management server 100A and/or the remote server 100B consistent with embodiments of the present invention. Note that some or all of the exemplary architecture, including both depicted hardware and software, shown for and within the computer 100 may be implemented in one or both of the servers 100A, 100B as shown in FIG. 2.

The computer 100 includes a processor unit 104 that is coupled to a system bus 106. Processor unit 104 may utilize one or more processors, each of which has one or more processor cores. A video adapter 108, which drives/supports a display 110, is also coupled to the system bus 106. The system bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and USB port(s) 126. While the format of the ports connected to I/O interface 116 may be any format known to those skilled in the art of computer architecture, in a preferred embodiment some or all of these ports are universal serial bus (USB) ports. As depicted, the computer 100 is able to communicate over a network using a network interface 130. The network may be the communication network 58 or the global communication network 56 shown in FIG. 2, or perhaps also an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes the operating system (OS) 138 and application programs 144 of the computer 100.

The operating system 138 includes a shell 140, for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the OS 138 also includes a kernel 142, which includes lower levels of functionality for the OS 138, including providing essential services required by other parts of the OS 138 and application programs 144, including memory management, process and task management, disk management, and mouse and keyboard management. The application programs 144 in the system memory of computer 100 may include various programs and modules for implementing the methods described herein, such as an interest level determination/access module 62, a map and location module 64, and/or an application/mode selection module 66.

The hardware elements depicted in computer 100 are not intended to be exhaustive, but rather are representative components suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

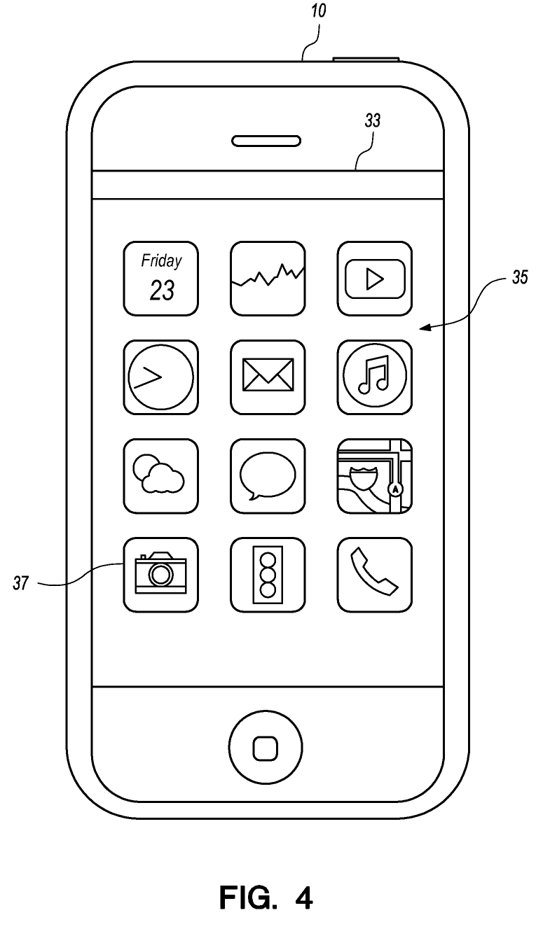

FIG. 4 is a diagram of a mobile communication device 10 having a display screen 33 displaying a user interface that includes a plurality of icons 35, where each icon represents an application available on the mobile communication device. In this example, assume that a user has taken the mobile communication device 10 with them to a zoo and, in accordance with various embodiments of the present invention, the mobile communication device is programmed to modify its user interface to facilitate the camera application. The camera application is represented by the lower left icon 37.

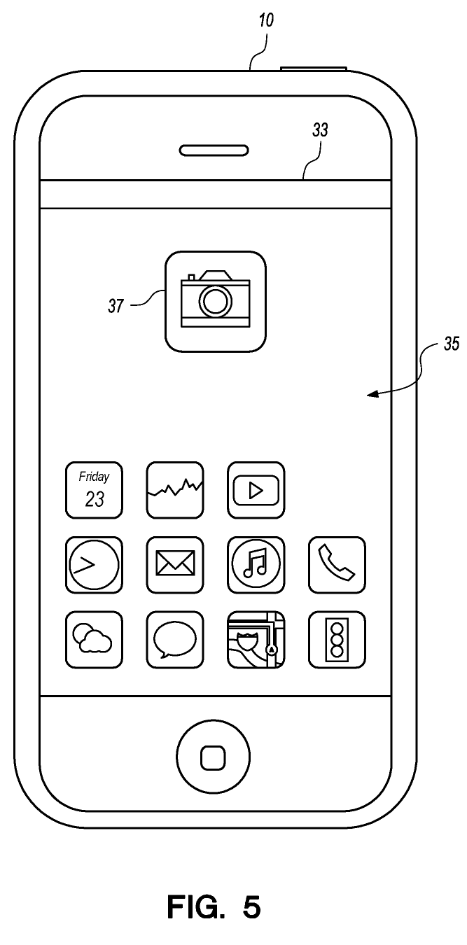

FIG. 5 is a diagram of the mobile communication device 10 having a display screen 33 displaying the user interface after rearranging the icons 35 to facilitate the user's access to the camera application icon 37. In this specific illustration, most of the icons 35 have been reduced in size and positioned at the bottom of the display screen 33, while the camera application icon 37 has been enlarged and moved to an upper middle position on the display screen 33.

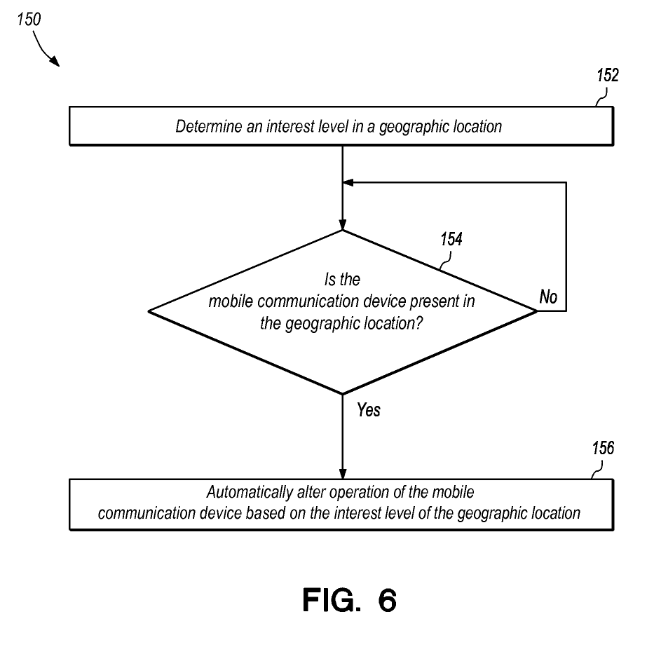

FIG. 6 is a flowchart of a method 150 in accordance with one embodiment of the present invention. In step 152, the method includes determining an interest level in a geographic location. In step 153, the method determines whether the mobile communication device is present in the geographic location. If the mobile communication device is not present in the geographic location, then the method simply waits. If the mobile communication is present in the geographic location, then the method automatically alters operation of the mobile communication device based on the interest level. Specific changes in the operation of the mobile communication device have been discussed above. It should also be recognized that the mobile communication device may, over a period of time, be taken in and out of any number of geographic locations. Accordingly, determining that the mobile communication device is present in any of the geographic locations may result in automatic alterations of one or more operations of the mobile communication device.

The foregoing computer program products may further include computer readable program code for implementing or initiating any one or more aspects of the methods described herein. Accordingly, a separate description of the methods will not be duplicated in the context of a computer program product.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a computer readable storage medium having program instructions embodied therewith, the program instructions executable by a processor to cause the processor to perform a method comprising:
determining an interest level in a geographic location; and
in response to a mobile communication device being present in the geographic location, automatically altering operation of the mobile communication device based on the interest level.

2. The computer program product of claim 1, wherein automatically altering operation of the mobile communication device based on the interest level includes automatically placing the mobile communication device in a sleep mode in response to determining that the interest level in the geographic location is less than a first predetermined interest threshold.

3. The computer program product of claim 2, wherein automatically altering operation of the mobile communication device based on the interest level includes automatically waking the mobile communication device out of a sleep mode in response to determining that the interest level in the geographic location is greater than a second predetermined interest threshold.

4. The computer program product of claim 1, wherein automatically altering operation of the mobile communication device based on the interest level includes the mobile communication device automatically loading a first application in response to determining that the interest level in the geographic location is greater than a first predetermined interest threshold.

5. The computer program product of claim 4, wherein the first application is a camera application or social media application.

6. The computer program product of claim 4, wherein automatically altering operation of the mobile communication device based on the interest level includes the mobile communication device automatically loading a second application in response to determining that the interest level in the geographic location is less than a second predetermined interest threshold.

7. The computer program product of claim 6, wherein the first application is a gaming application or social media application.

8. The computer program product of claim 1, further comprising:
identifying content that is accessed the most by mobile communication devices in the geographic location, wherein automatically altering operation of the mobile communication device based on the interest level includes the mobile communication device automatically loading an application that will access that content.

9. The computer program product of claim 8, further comprising:
the mobile communication device automatically downloading the content using the application.

10. The computer program product of claim 1, further comprising:
identifying content that is accessed the most by mobile communication devices in the geographic location; and then
storing the identified content at an access point of a mobile communication network that is nearest to the geographic region.

11. The computer program product of claim 1, further comprising:
identifying a type of application that is used the most by mobile communication devices in the geographic location;
identifying an application on the mobile communication device that is the identified type of application; and
the mobile communication device automatically loading the identified application.

12. The computer program product of claim 1, further comprising:
identifying a type of application that is used the most by mobile communication devices in the geographic location;
identifying an application on the mobile communication device that is the identified type of application; and
automatically directing the user interface of the mobile communication device to display an icon for the identified application.

13. The computer program product of claim 1, further comprising:
identifying a location type for the geographic location;
maintaining a list of location types and an application associated with each location type; and
the mobile communication device automatically loading the application that is associated with the identified location type.

14. The computer program product of claim 1, wherein determining the interest level in the geographic location includes determining whether a majority of mobile activity in the geographic location is related to the geographic location.

15. The computer program product of claim 1, wherein the geographic location is defined by coordinates of a global positioning system.

16. A method comprising:
determining an interest level in a geographic location; and
in response to a mobile communication device being present in the geographic location, automatically altering operation of the mobile communication device based on the interest level.

17. The method of claim 16, wherein automatically altering operation of the mobile communication device based on the interest level includes automatically placing the mobile communication device in a sleep mode in response to determining that the interest level in the geographic location is less than a first predetermined interest threshold.

18. The method of claim 17, wherein automatically altering operation of the mobile communication device based on the interest level includes automatically waking the mobile communication device out of a sleep mode in response to determining that the interest level in the geographic location is greater than a second predetermined interest threshold.

19. The method of claim 16, wherein automatically altering operation of the mobile communication device based on the interest level includes the mobile communication device automatically loading a first application in response to determining that the interest level in the geographic location is greater than a first predetermined interest threshold.

20. The method of claim 19, wherein automatically altering operation of the mobile communication device based on the interest level further includes the mobile communication device automatically loading a second application in response to determining that the interest level in the geographic location is less than a second predetermined interest threshold.
